(19) United States
(12) Patent Application Publication
(10) Pub. No.: US 2025/0274554 A1
(43) Pub. Date: Aug. 28, 2025

(54) MULTIFUNCTION PRINTER

(71) Applicant: BROTHER KOGYO KABUSHIKI KAISHA, Nagoya (JP)

(72) Inventors: Yoshihiro OKAMOTO, Komaki (JP); Hiroaki SHIGENO, Nagoya (JP)

(73) Assignee: BROTHER KOGYO KABUSHIKI KAISHA, Nagoya (JP)

(21) Appl. No.: 19/065,147

(22) Filed: Feb. 27, 2025

(30) Foreign Application Priority Data
Feb. 28, 2024 (JP) 2024-028594

(51) Int. Cl. H04N 1/00; B41J 3/46; B41J 29/02; B41J 29/13; G03G 15/00; G03G 15/22; G03G 21/16

(52) U.S. Cl. CPC H04N 1/00557; H04N 1/00559; B41J 3/46; B41J 29/02; B41J 29/13; G03G 15/228; G03G 15/5016; G03G 15/80; G03G 21/1619; G03G 21/1633; H04N 2201/0094

(57) ABSTRACT

A multifunction printer includes an image forming unit configured to form an image on a sheet, an image reading unit configured to read an image of a document, an operation panel configured to receive an operation, a lower housing configured to house the image forming unit, an upper housing configured to house the image reading unit, the upper housing being located above the lower housing, a panel housing configured to house the operation panel, the panel housing being located above the lower housing and located in front of the upper housing, a connection part connecting the lower housing to the upper housing, and a support part configured to support the panel housing, the support part being located between the lower housing and the panel housing in an upward-and-downward direction, the support part being located in front of the upper housing and the connection part.

### REFERENCE TO RELATED APPLICATIONS

This application claims priority from Japanese Patent Application No. 2024-028594 filed on Feb. 28, 2024. The entire content of the priority application is incorporated herein by reference.

### BACKGROUND ART

A related art discloses an example of a multifunction printer. In this multifunction printer, an upper housing that houses an image reading unit is located above a lower housing that houses the image forming unit. A panel housing that houses an operation panel is located above the lower housing and protrudes forwards from the front end of the upper housing. It is not clear whether at least a part of the panel housing is formed to be integrated with the upper housing, but in general, at least a part of the panel housing is often formed to be integrated with the upper housing. A connection part connects the lower housing to the upper housing.

This multifunction printer is required to support the operation panel with strength capable of withstanding pressing force applied to the operation panel that receives an operation input. For this reason, in this multifunction printer, the front end of the connection part is located between the lower housing and the panel housing in the upward-and-downward direction, and is located in front of the upper housing so as to support the panel housing.

In addition, as another example of a conventional multifunction printer, there is a configuration in which the front end of a connection part is located behind a panel housing and does not support the panel housing. In this multifunction printer, at least a part of the panel housing is formed to be integrated with an upper housing, thereby ensuring strength to withstand pressing force applied to an operation panel.

However, in the above-mentioned multifunction printer, there is a case of adopting product development in which operation panels having different sizes are formed to be integrated with an upper housing.

When such product development is implemented in a configuration in which at least a part of a panel housing is formed to be integrated with the upper housing, it is necessary to design, manufacture, and store a plurality of types of upper housing components having shapes that respectively match the sizes of the operation panels. As a result, when a production plan and demand are unexpectedly changed from the original plan, it is difficult to respond to the unexpected state, and it is also necessary to secure a space to store the plurality of types of upper housing components.

When such product development is implemented in a configuration in which the front end of a connection part supports the panel housing, it is also necessary to design, manufacture, and store a plurality of types of connection parts having shapes that respectively match the sizes of the operation panels, leading to a problem similar to the above-described problem. In this case, if at least a part of the panel housing is formed to be integrated with the upper housing, the problem becomes even more serious.

The present disclosure has been made in consideration of the above-mentioned conventional circumferences, and an object thereof is to provide a multifunction printer configured, in a configuration in which operation panels having different sizes are formed to be integrated with an upper housing, not only to secure strength to withstand pressing force applied to the operation panel without connecting a panel housing to the upper housing, but also to reduce the number of housing components to be stored when a plurality of types of products are manufactured.

### SUMMARY

A multifunction printer including: an image forming unit configured to form an image on a sheet; an image reading unit configured to read an image of a document; an operation panel configured to receive an operation; a lower housing configured to house the image forming unit; an upper housing configured to house the image reading unit, the upper housing being located above the lower housing; a panel housing configured to house the operation panel, the panel housing being located above the lower housing and located in front of the upper housing; a connection part connecting the lower housing to the upper housing; and a support part configured to support the panel housing, the support part being located between the lower housing and the panel housing in an upward-and-downward direction, the support part being located in front of the upper housing and the connection part, in which the support part includes: a first support part fixed to the panel housing; and a second support part fixed to the lower housing and configured to be connected to the first support part.

### BRIEF DESCRIPTION OF DRAWINGS

FIG. 1 is a perspective view of a multifunction printer of an embodiment, illustrating a combination of a large-sized upper housing and a large-sized panel housing;

FIG. 2 is a partial perspective view of the multifunction printer of the embodiment, illustrating the combination of the large-sized upper housing and the large-sized panel housing;

FIG. 3 is a partial perspective view similar to FIG. 1, illustrating a state in which a document cover is removed;

FIG. 4 is a perspective view of a joint cover;

FIG. 5 is a partial perspective view of the joint cover;

FIG. 6 is a partial top view of the multifunction printer of the embodiment, in which the partial top view illustrates the state in which the document cover is removed and the combination of the large-sized upper housing and the large-sized panel housing;

FIG. 7 is a partial top view similar to FIG. 6, illustrating a combination of a small-sized upper housing and a small-sized panel housing;

FIG. 8 is a partial top view similar to FIG. 6, illustrating a combination of the large-sized upper housing and a medium-sized panel housing;

FIG. 9 is a partial perspective view similar to FIG. 2, illustrating a state in which an exterior cover is removed;

FIG. 10 is a partial cross-sectional view illustrating a cross section taken along line A-A in FIG. 6;

FIG. 11 is a partial cross-sectional view illustrating a cross section taken along line B-B in FIG. 6;

FIG. 12 is a perspective view of a panel housing and a first support part;

FIG. 13 is a perspective view of the panel housing;

FIG. 14 is a perspective view of the first support part;

FIG. 15 is a perspective view of the first support part;

FIG. 16 is a perspective view of a second support part;

FIG. 17 is a perspective view of the second support part;

FIG. 18 is a top view of the second support part; and

FIG. 19 is a partial perspective view of the exterior cover.

### DESCRIPTION

Hereinafter, an embodiment of the present disclosure will be described with reference to the drawings.

### Embodiment

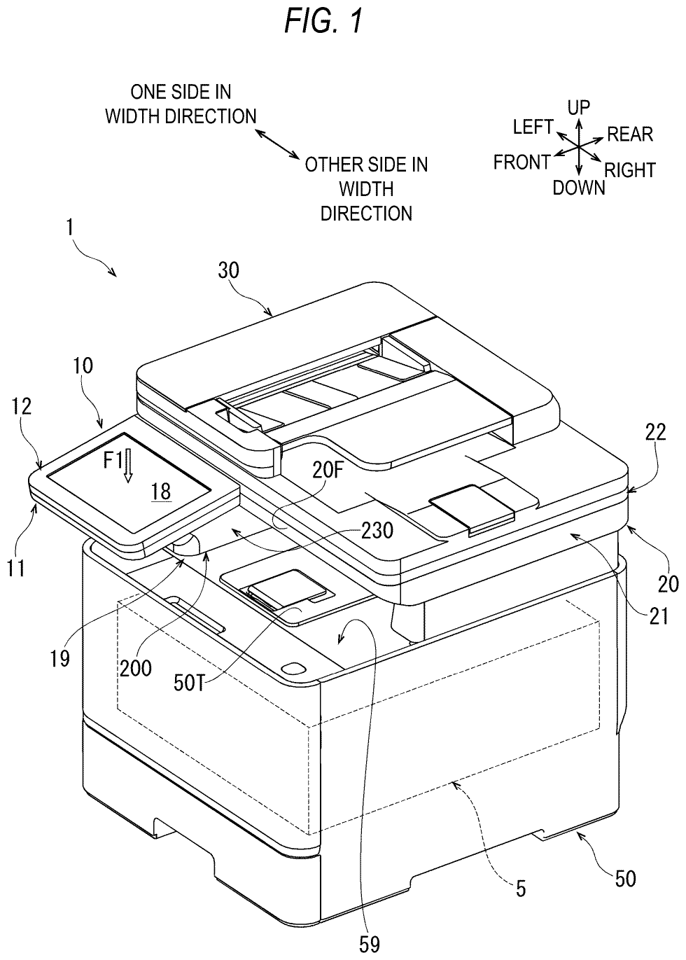

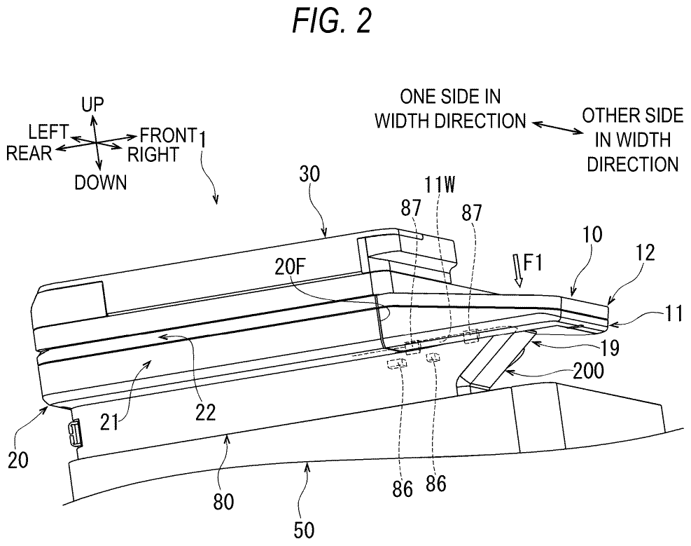

As illustrated in FIG. 1, a multifunction printer 1 of an embodiment is an example of a specific aspect of a multifunction printer of the present disclosure. In FIG. 1, the side of an operation panel 18 of the multifunction printer 1 is defined as a front side. The left side when facing the operation panel 18 is defined as a left side. The respective directions illustrated in FIG. 2 and subsequent drawings are all displayed corresponding to the respective directions illustrated in FIG. 1.

A width direction of the multifunction printer 1 is a direction perpendicular to a forward-and-rearward direction and an upward-and-downward direction, and is parallel to a leftward-and-rightward direction. In the present embodiment, the left side is one side in the width direction, and the right side is the other side in the width direction. The width direction is an example of a “second direction” of the present disclosure. In the present embodiment, one side in the width direction is the same as one side in the second direction, and the other side in the width direction is the same as the other side in the second direction. The width directions illustrated in FIG. 2 and subsequent drawings are all displayed corresponding to the width direction illustrated in FIG. 1.

### Housing, Connection Part, and Upper Housing

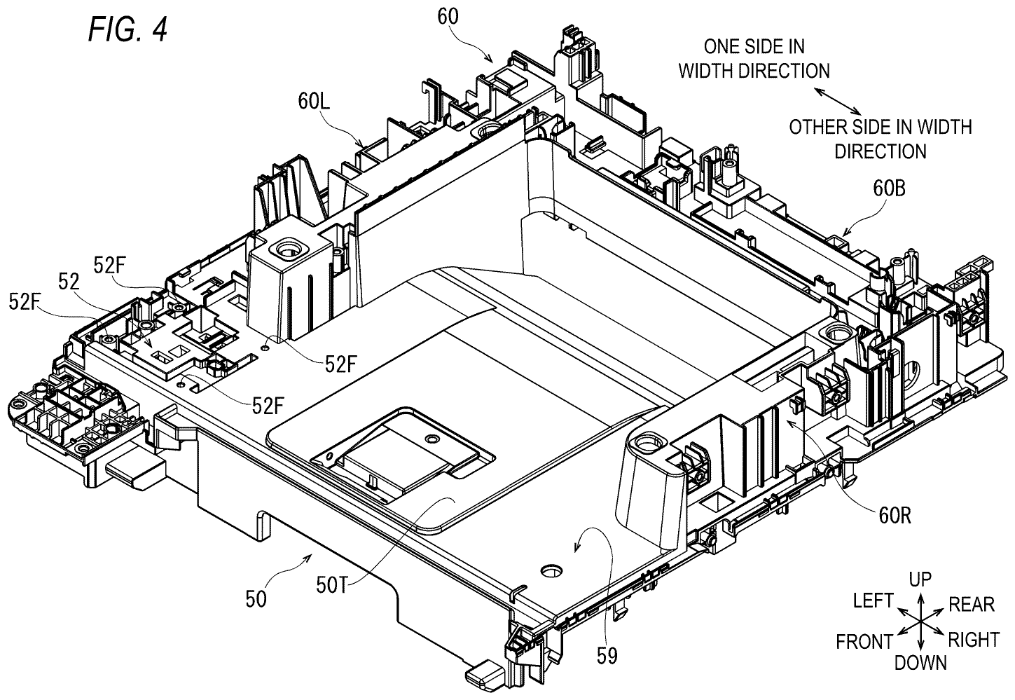

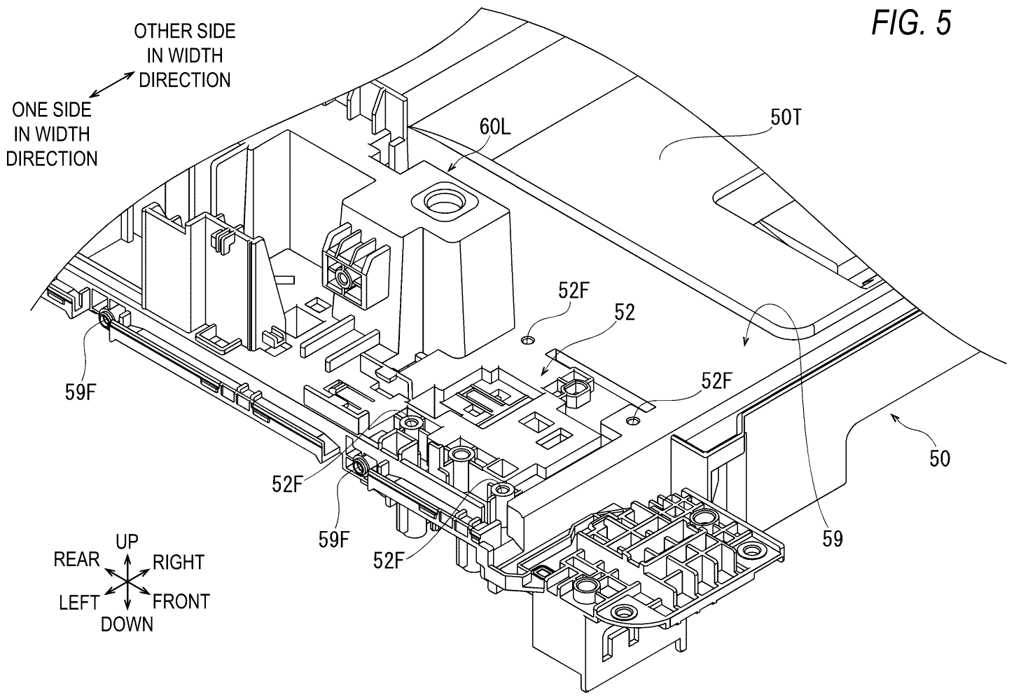

The multifunction printer 1 includes a lower housing 50 and an upper housing 20 illustrated in FIGS. 1 to 3, and a connection part 60 illustrated in FIGS. 4 and 5.

As illustrated in FIG. 1, the lower housing 50 is formed to have a substantially box-shape and includes a joint cover 59 on the upper surface side of the lower housing 50. As illustrated in FIGS. 4 and 5, the joint cover 59 extends in the forward-and-rearward direction and the width direction, and covers the internal space of the lower housing 50 from above. In the present embodiment, the joint cover 59 is a resin member manufactured by injection molding of thermoplastic resin or the like.

As illustrated in FIG. 4, a discharge tray 50T is formed at the center of the upper surface of the joint cover 59 in the width direction. The discharge tray 50T is inclined upwards from the rear end side of the joint cover 59 in the forward direction, and then extends in the forward direction approximately horizontally toward the front end edge of the upper surface of the lower housing 50.

The connection part 60 is formed to be integrated with the joint cover 59. The connection part 60 includes a first connection part 60L, a second connection part 60R, and a third connection part 60B.

The first connection part 60L protrudes upwards from a position on the left side of the discharge tray 50T on the joint cover 59, and extends in the forward-and-rearward direction. The second connection part 60R protrudes upwards from a position on the right side of the discharge tray 50T on the joint cover 59, and extends in the forward-and-rearward direction.

The third connection part 60B protrudes upwards from a position on the rear side of the discharge tray 50T on the joint cover 59, and extends in the width direction. The left end of the third connection part 60B is connected to the rear end of the first connection part 60L. The right end of the third connection part 60B is connected to the rear end of the second connection part 60R.

As illustrated in FIG. 5, the lower housing 50 includes a base part 52. The base part 52 is formed at a position on the front side of the front end of the first connection part 60L on the joint cover 59, and at a position on the left side of the front portion of the discharge tray 50T. The upper surface of the base part 52 extends horizontally. The base part 52 is provided with four screw holes 52F, a plurality of recessed portions, and the like.

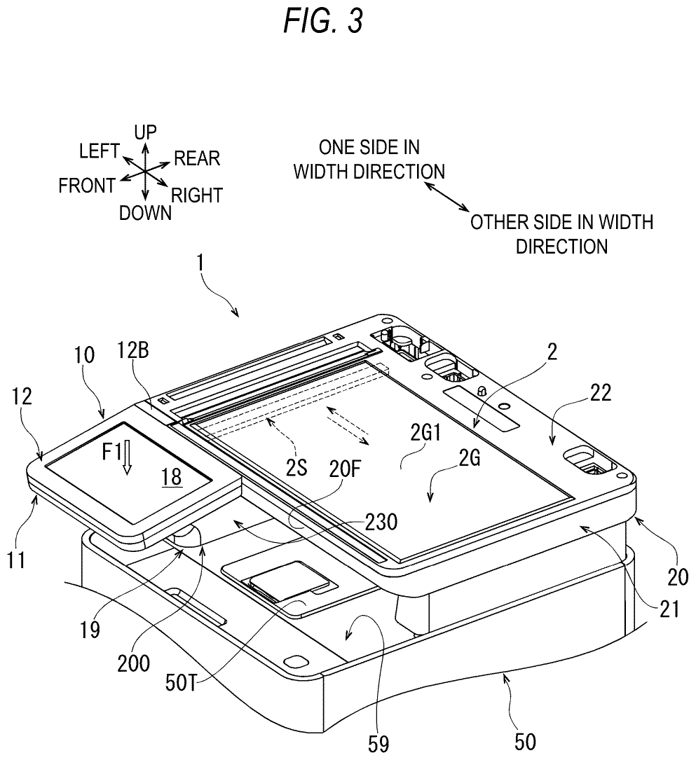

As illustrated in FIG. 3, the upper housing 20 is located above the lower housing 50. The upper housing 20 includes a flat base 21 and an upper surface cover 22. The flat base 21 is a flat box-shaped body, the length in the upward-and-downward direction of which is significantly smaller than that of the lower housing 50, and has an open upper surface side. The upper surface cover 22 is attached to the upper surface side of the flat base 21. A front wall 20F of the upper housing 20 extends in the width direction at a position away from the front surface of the lower housing 50 to the rear side.

In the present embodiment, the flat base 21 and the upper surface cover 22 are resin members manufactured by injection molding of thermoplastic resin or the like.

The first connection part 60L, the second connection part 60R, and the third connection part 60B illustrated in FIG. 4 connect the lower housing 50 to the upper housing 20 in a state of being covered with a plurality of exterior covers, as illustrated in FIG. 2 and FIG. 3.

### Image Forming Unit

As illustrated in FIG. 1, the multifunction printer 1 includes an image forming unit 5. The lower housing 50 houses the image forming unit 5. The image forming unit 5 is a well-known configuration, so illustration and description will be simplified. The image forming unit 5 forms an image on a sheet by an inkjet method or an electrophotographic method, and is configured to discharge the sheet to the discharge tray 50T.

### Image Reading Unit

As illustrated in FIG. 3, the multifunction printer 1 includes an image reading unit 2. The upper housing 20 houses the image reading unit 2. The image reading unit 2 includes a document glass 2G and a reading sensor 2S.

The document glass 2G is disposed on the upper surface of the upper housing 20. The upper surface cover 22 covers the outer circumferential edge of the document glass 2G. The document glass 2G includes a document placement surface 2G1 surrounded by the upper surface cover 22 and oriented upwards. A document to be read is placed on the document placement surface 2G1.

The reading sensor 2S is configured to move in the leftward-and-rightward direction, which is the sub-scanning direction, below the document placement surface 2G1, and is configured to read an image of the document in a line shape in the forward-and-rearward direction, which is the main scanning direction.

### Document Cover

As illustrated in FIGS. 1 and 2, the multifunction printer 1 includes a document cover 30. The document cover 30 is located above the upper housing 20. The rear end of the document cover 30 is connected to the upper housing 20 via a hinge (not illustrated), so that the document cover is configured to be opened and closed.

In a state where the document cover 30 is closed, the document cover 30 covers the document placement surface 2G1. On the other hand, although not illustrated, in a state where the document cover 30 is opened, the document cover exposes the document placement surface 2G1. In this state, a user can place a document on the document placement surface 2G1 or remove the document placed thereon.

### Size of Lower Housing, Upper Housing, and the Like

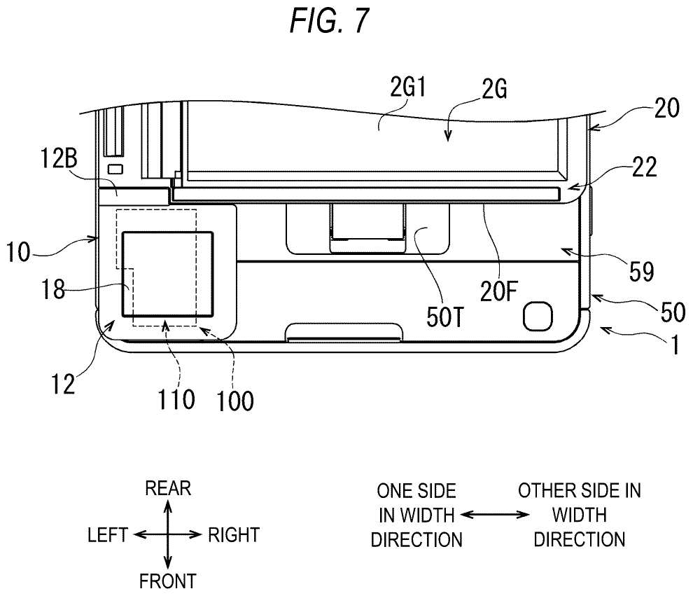

As illustrated in FIGS. 1 to 3 and 6 to 8, in the present embodiment, the multifunction printer 1 has only one size for the lower housing 50. On the other hand, the multifunction printer 1 has two sizes for the upper housing 20, in which the two sizes include a “large” size illustrated in FIGS. 1 to 3, 6 and 8, and a “small” size illustrated in FIG. 7, corresponding to the size of the document to be read.

The multifunction printer 1 also has two sizes for the document cover 30, in which the two sizes include a “large” size illustrated in FIG. 1 and FIG. 2 and a “small” size not illustrated, corresponding to the two sizes of the upper housing 20. The joint cover 59 has only one size, and the connection part 60 is provided to correspond to the “large” and “small” sizes of the upper housing 20.

### Operation Panel and Panel Housing

As illustrated in FIG. 1 and FIG. 3, the multifunction printer 1 includes the operation panel 18 and a panel housing 10.

Although the operation panel 18 has a well-known configuration and will not be described here, the operation panel 18 includes a transparent touch panel and a display unit disposed on the back surface side of the touch panel. The operation panel 18 is configured to receive an operation made by a user to instruct the image forming unit 5, the image reading unit 2, and the like to be operated, and to perform settings thereof. The operation panel 18 is configured to display images illustrating operating states and settings of the image forming unit 5, image reading unit 2, and the like.

A direction of pressing force F1 acting on the operation panel 18 configured to receive the operation is a downward direction in the vertical direction. The downward direction in the vertical direction is an example of a “first direction” of the present disclosure.

As illustrated in FIGS. 1 to 3 and 9, the panel housing 10 is located above the lower housing 50 and is in front of the upper housing 20. The panel housing 10 is supported by a support part 19, which will be described later. The rear end of the panel housing 10 is adjacent to a portion located on the left end side of a front wall 20F of the upper housing 20. The panel housing 10 is inclined such that the front end of the panel housing is located lower than the rear end of the panel housing.

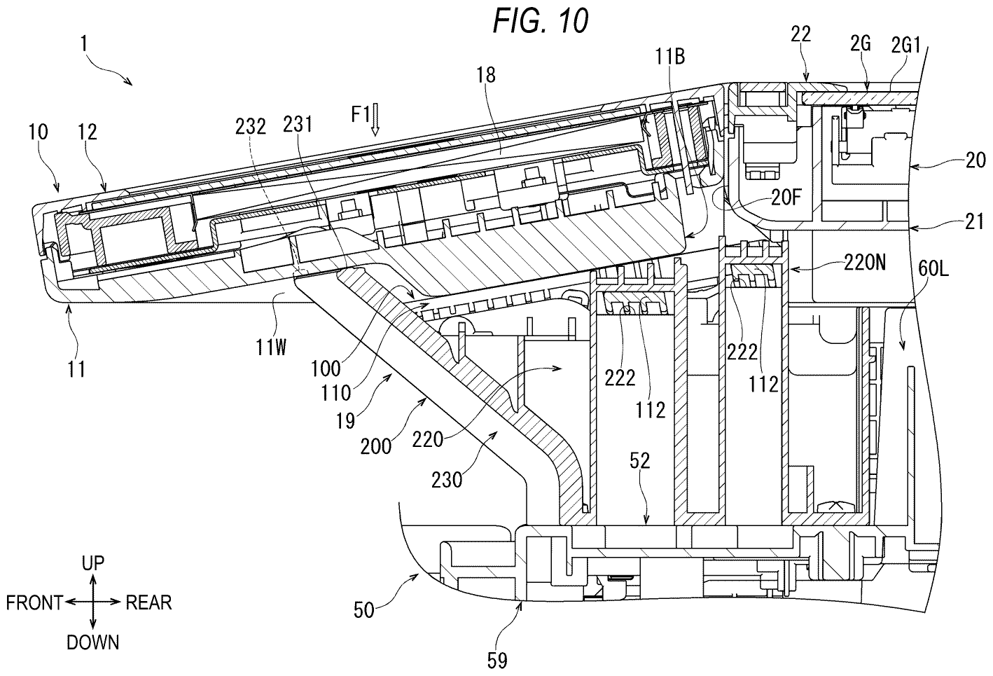

As illustrated in FIGS. 10 to 13, the panel housing 10 includes a panel base 11 and a panel cover 12. The panel base 11 is formed to have a flat and approximately box-shaped body, and the upper surface side thereof is opened. The panel cover 12 is attached to the upper surface side of the panel base 11.

In the present embodiment, the panel base 11 and the panel cover 12 are resin members manufactured by injection molding of thermoplastic resin or the like.

As illustrated in FIGS. 3 and 10, the panel housing 10 houses the operation panel 18. The panel cover 12 covers the outer circumferential edge of the operation panel 18.

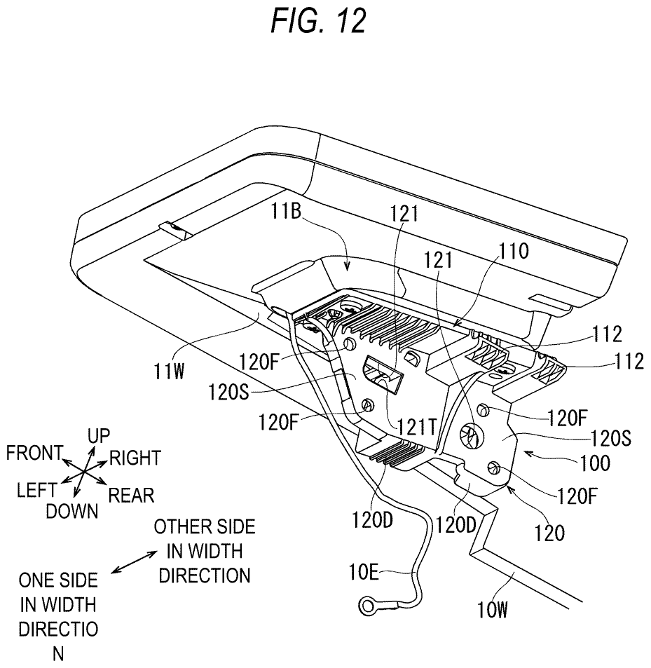

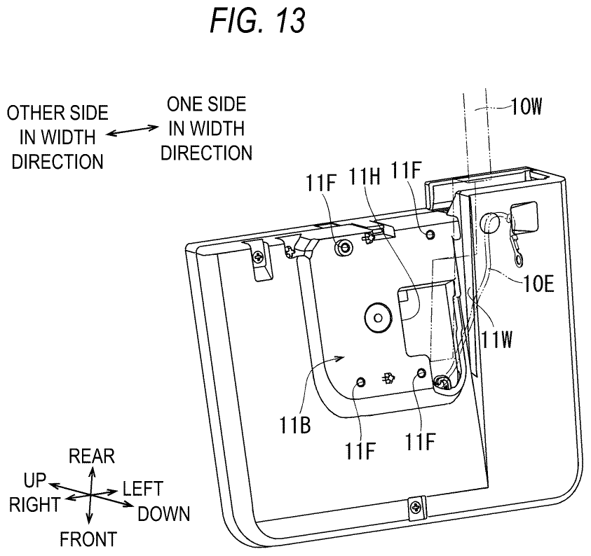

As illustrated in FIGS. 12 and 13, the panel base 11 includes a base part 11B. The base part 11B is located at the center in the width direction of the bottom wall of the panel base 11, and a portion of the base located from the center in the forward-and-rearward direction to the rear end bulges downwards.

As illustrated in FIG. 10, the lower surface of the base part 11B is inclined such that the front end of the base is located lower than the rear end of the base. As illustrated in FIG. 13, four screw holes 11F are formed in the base part 11B. The base part 11B also has a substantially rectangular opening 11H.

The opening 11H is provided to pull a wire harness 10W and an earth wire 10E from inside the panel housing 10 to the outside. The wire harness 10W is a collection of multiple electrical wirings connected to the operation panel 18. The earth wire 10E is also connected to the operation panel 18.

As illustrated in FIG. 3 and FIG. 13, a portion 12B located on the rear and left end side of the panel cover 12 is a substantially rectangular plate-like piece that protrudes rearwards further than the other portions on the rear end side of the panel cover 12.

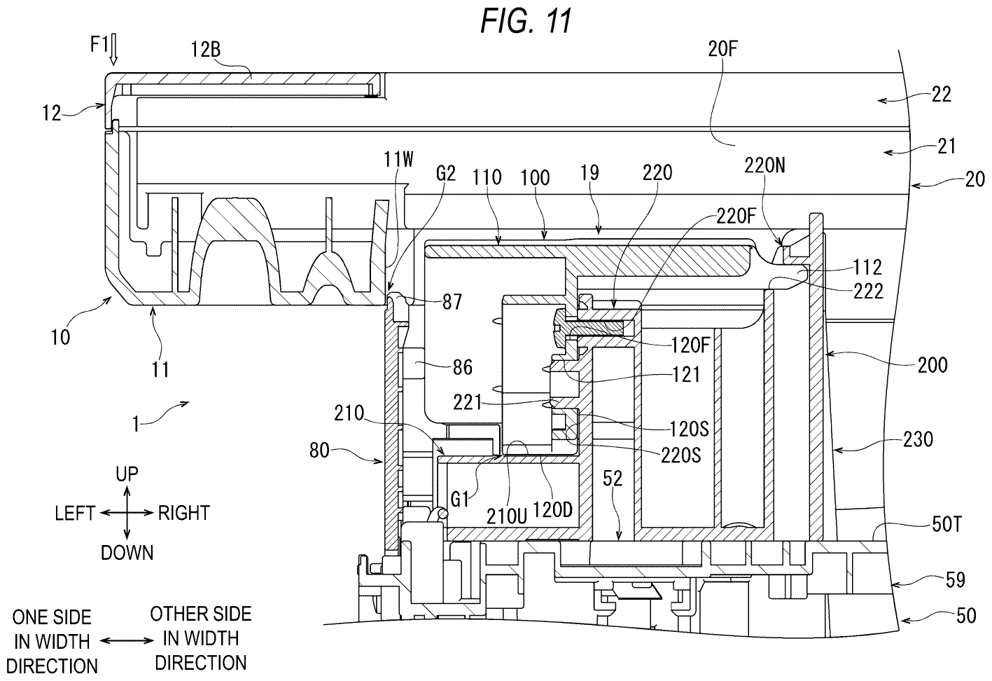

As illustrated in FIGS. 3 and 11, the portion 12B of the panel cover 12 covers a corner portion of the front end side and the left end side of the upper surface cover 22 from above, in a state where the upper surface of the portion is flush with the upper surface of the upper surface cover 22.

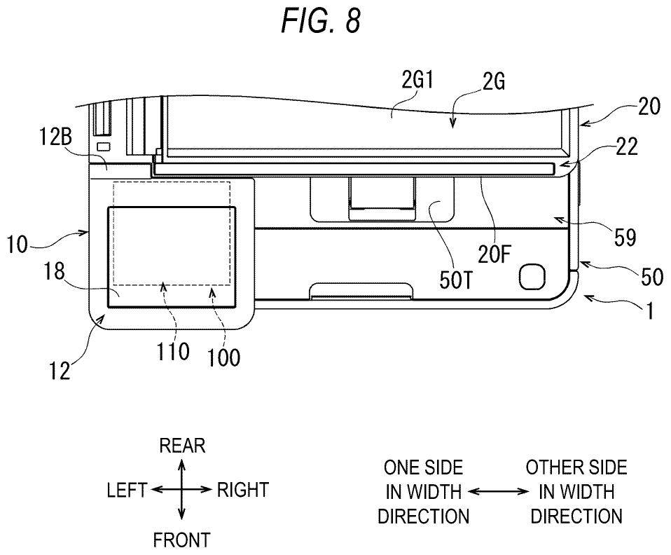

In the present embodiment, the multifunction printer 1 has three sizes for the operation panel 18, in which the three sizes include a “large” size illustrated in FIGS. 1, 3, 6 and 10, a “small” size illustrated in FIG. 7, and a “medium” size illustrated in FIG. 8. Accordingly, the multifunction printer 1 has three sizes for the panel housing 10, in which the three sizes include a “large” size illustrated in FIGS. 1 to 3, 6, and 9 to 13, a “small” size illustrated in FIG. 7, and a “medium” size illustrated in FIG. 8.

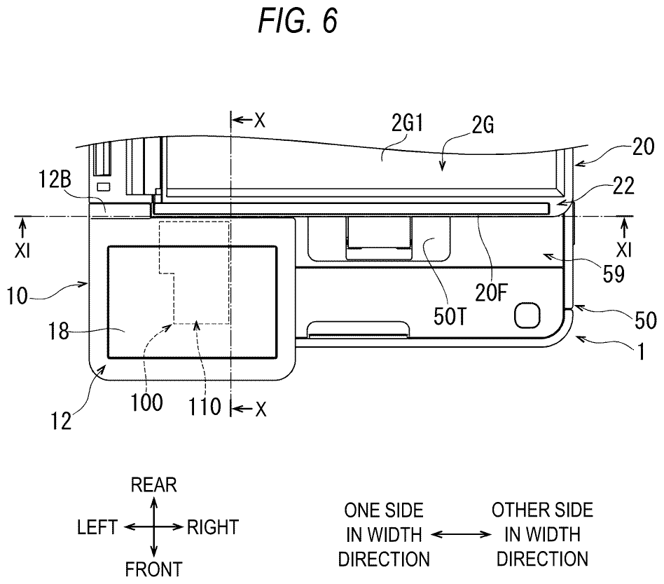

As illustrated in FIGS. 6 and 8, the left side surface of the panel housings 10 of the “large” and “medium” size is approximately flush with the left side surface of the upper housing 20 of the “large” size. As illustrated in FIG. 7, the left side surface of the panel housing 10 of the “small” size is substantially flush with the left side surface of the upper housing 20 of the “small” size. In other words, in the multifunction printer 1, the left side surface of the upper housing 20 and the left side surface of the panel housing 10 are substantially flush with each other such that a combination of the upper housing 20 and the panel housing 10 does not cause any sense of incongruity in design.

### Support Part

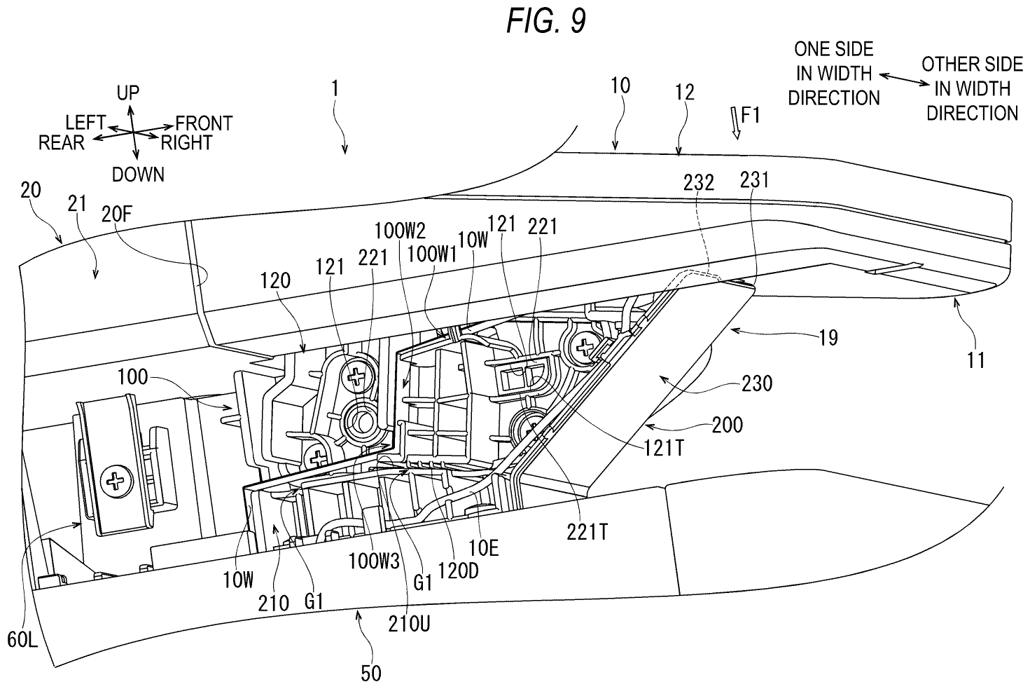

As illustrated in FIG. 9, the multifunction printer 1 has a support part 19. The support part 19 is located between the lower housing 50 and the panel housing 10 in the upward-and-downward direction, and is located in front of the upper housing 20 and the first connecting part 60L of the connection part 60.

As illustrated in FIGS. 9 to 11, the support part 19 supports the panel housing 10. The support part 19 will be described in detail below.

The support part 19 is configured to have a first support part 100 and a second support part 200. As illustrated in FIG. 9, the support part 19 includes two sets of first fitting parts 221 and first fitted parts 121. As illustrated in FIG. 11, the support part 19 includes two sets of second fitting parts 112 and second fitted parts 222.

Each of the first fitting parts 221 and each of the second fitting parts 112 is an example of a “fitting part” of the present disclosure. Each of the first fitted parts 121 and each of the second fitted parts 222 is an example of a “fitted part” of the present disclosure.

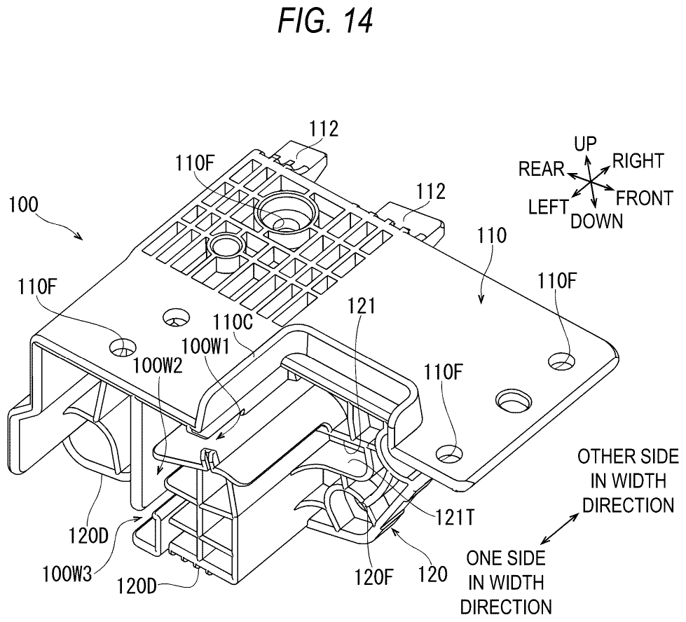

As illustrated in FIG. 14, the first fixing part 110 is a substantially flat plate shape extending along the lower surface of the base part 11B of the panel housing 10. Four screw insertion holes 110F and a C-shaped rib 110C are formed in the first fixing part 110.

The C-shaped rib 110C protrudes upwards from a portion of the first fixing part 110, the portion being located at the front side and one side of the width direction, and extends along the inner circumferential edge of the opening 11H of the base part 11B. The C-shaped rib 110C is substantially “C” shaped when viewed from above.

As illustrated in FIG. 12, the first fixing part 110 is coupled to the base part 11B of the panel base 11 by inserting four screws into the screw insertion holes 110F and screwing them into the respective screw holes 11F of the panel base 11. In this manner, the first fixing part 110 is fixed to the panel base 11 of the panel housing 10.

The first mounting part 120 is connected to the first fixing part 110 and extends downwards and in the forward-and-rearward direction. A first side surface 120S of the first mounting part 120 is a flat surface that faces the other side in the width direction, and extends in the forward-and-rearward direction and the upward-and-downward direction. As illustrated in FIG. 11, the first mounting part 120 extends toward the base part 52 of the lower housing 50.

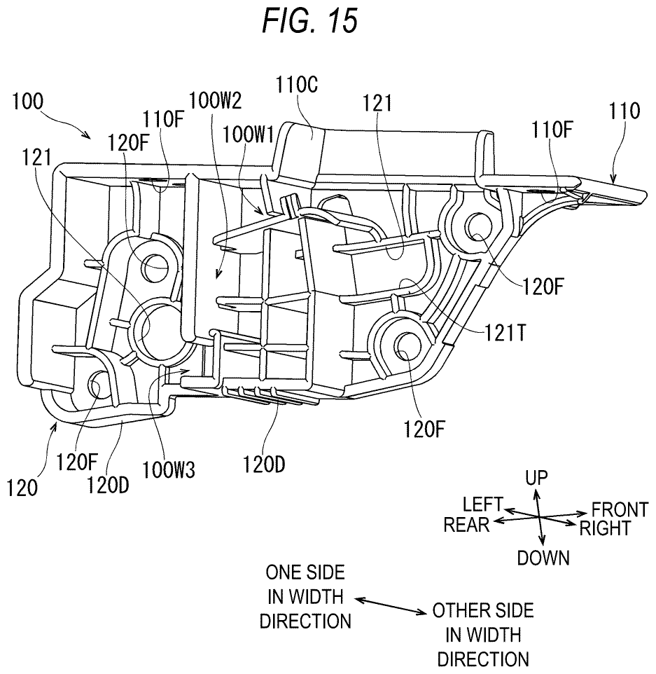

As illustrated in FIG. 15, the first mounting part 120 has a plurality of ribs that intersect each other on the side opposite the first side surface 120S, thereby increasing its rigidity. A bottom surface 120D of the first mounting part 120 is formed by the lower end surfaces of the plurality of ribs that are located at the lowest of the ribs, and a large length in the width direction is secured.

The first mounting part 120 has four screw insertion holes 120F. The two screw insertion holes 120F located at the front end side of the first mounting part 120 are spaced apart from each other in the upward-and-downward direction. The two screw insertion holes 120F located at the rear end side of the first mounting part 120 are also spaced apart from each other in the upward-and-downward direction.

As illustrated in FIG. 15, the first support part 100 includes guide parts 100W1, 100W2, and 100W3.

The guide parts 100W1, 100W2, and 100W3 are formed by some of the surfaces of the plurality of ribs formed on the opposite side of the first side surface 120S of the first mounting part 120, or by gaps between the ribs.

As illustrated in FIG. 9, the guide parts 100W1, 100W2, and 100W3 guide the wire harness 10W that has passed through the opening 11H of the panel housing 10 to the rear side and a lower corner portion of the first mounting part 120, while bending the wire harness a plurality of times.

### Second Fitting Part

As illustrated in FIGS. 12 and 14, two second fitting parts 112 are formed on the first fixing part 110 of the first support part 100. Each of the second fitting part 112 protrudes in a fitting direction from the right end edge located on the other side in the width direction of the first fixing part 110.

The fitting direction is perpendicular to a direction of the pressing force F1 acting on the operation panel 18, that is, the downward direction in the vertical direction. In the present embodiment, the fitting direction is parallel to the width direction. Each of the second fitting part 112 protrudes toward the other side in the width direction.

As illustrated in FIGS. 10 and 12, each of the second fitting parts 112 includes a flat plate extending approximately horizontally in the forward-and-rearward direction and the width direction, and a plurality of ribs protruding downwards from the lower surface of the flat plate and extending in the width direction. The front second fitting part 112 is located lower than the rear second fitting part 112.

### First Fitted Part

As illustrated in FIGS. 12 and 15, two first fitted parts 121 are formed in the first mounting part 120 of the first support part 100. Each of the first fitted parts 121 is recessed from the first side surface 120S of the first mounting part 120 in the fitting direction. Each of the first fitted parts 121 is recessed from the first side surface 120S toward one side in the width direction and penetrates the first mounting part 120.

The first fitted part 121 located on the rear end side of the first mounting part 120 is a hole having a cylindrical inner circumferential surface.

The first fitted part 121 located at the front end side of the first mounting part 120 is an elongated hole having a receiving part 121T, and extends in the forward-and-rearward direction. In the receiving part 121T, a part below the inner circumferential surface of the first fitted part 121 is formed in a flat shape.

### Second Support Part

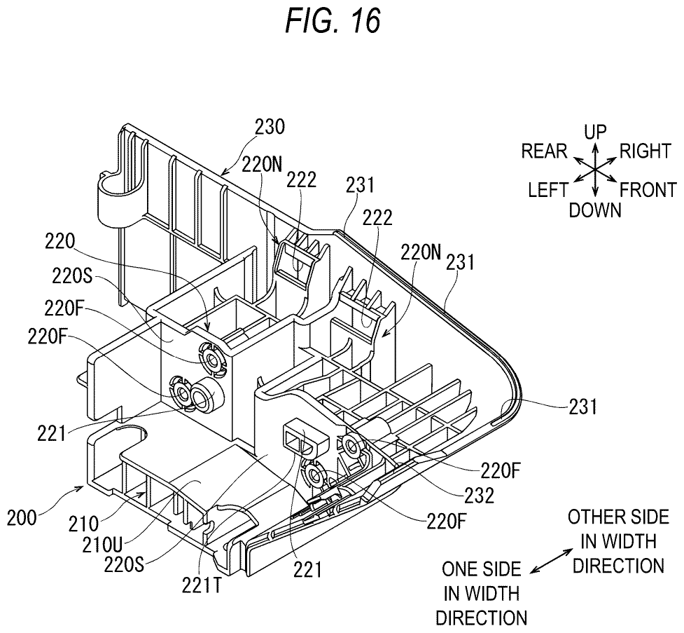

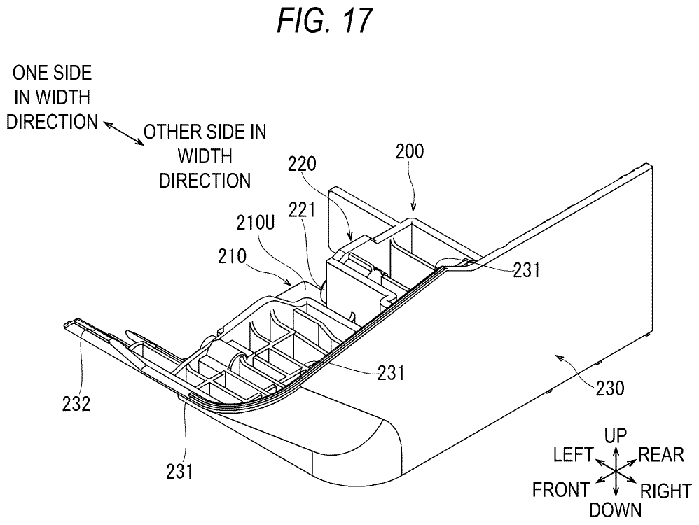

As illustrated in FIGS. 16 to 18, a second support part 200 integrally includes a second fixing part 210, a second mounting part 220, and a cover part 230. In the present embodiment, the second support part 200 is a resin member manufactured by injection molding of a thermoplastic resin or the like.

As illustrated in FIGS. 11 and 16, the second fixing part 210 extends in the forward-and-rearward direction and width direction along the base part 52 of the lower housing 50. The second fixing part 210 has a plurality of ribs that intersect each other such that a thickness thereof in the upward-and-downward direction is increased to improve rigidity.

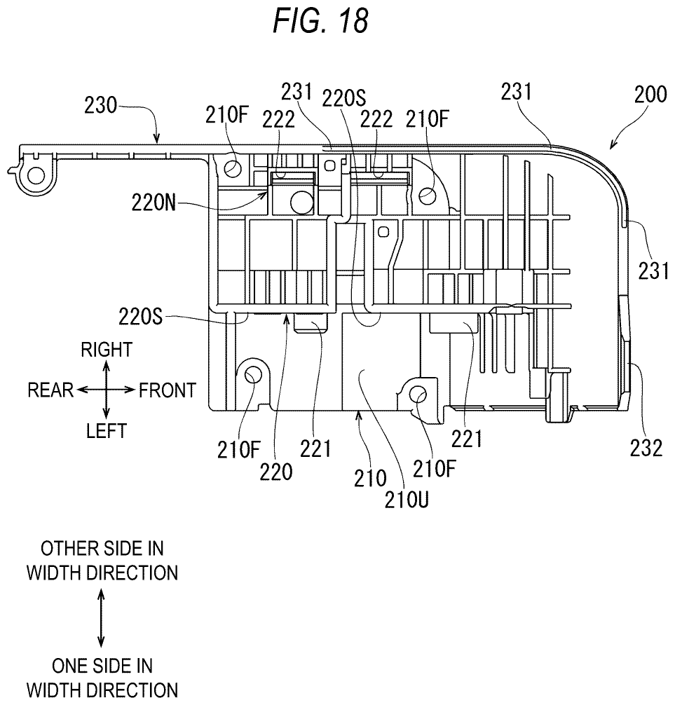

As illustrated in FIG. 18, screw insertion holes 210F are respectively formed in the four corner portions on the lower surface side of the second fixing part 210.

The second fixing part 210 is coupled to the base part 52 of the joint cover 59 by inserting four screws into the respective screw insertion holes 210F and screwing them into the respective screw holes 52F of the base part 52. In this manner, as illustrated in FIG. 9 to FIG. 11, the second fixing part 210 is fixed to the base part 52 of the lower housing 50.

As illustrated in FIG. 16, an upper surface 210U of the second fixing part 210 has a large length in the width direction, similarly to the bottom surface 120D of the first mounting part 120.

The second mounting part 220 is connected to the second fixing part 210, and extends upwards and extends in the forward-and-rearward direction. A second side surface 220S of the second mounting part 220 is a flat surface oriented toward one side in the width direction, and formed to extend in the forward-and-rearward direction and the upward-and-downward direction.

The lower end edge of the second side surface 220S is connected to the other end edge in the width direction of the upper surface 210U. As illustrated in FIGS. 10 and 11, the second mounting part 220 extends toward the panel base 11 of the panel housing 10.

As illustrated in FIG. 16, four screw holes 220F are formed in the second mounting part 220. The two screw holes 220F located at the front end side of the second mounting part 220 are spaced apart from each other in the upward-and-downward direction. The two screw holes 220F located at the rear end side of the second mounting part 220 are also spaced apart from each other in the upward-and-downward direction.

As illustrated in FIGS. 16 to 18, the cover part 230 is connected to the front end of the second fixing part 210, the front end of the second mounting part 220, and the other end in the width direction of the second mounting part 220, and forms the exterior surface of the second support part 200.

A portion of the cover part 230 extending rearwards beyond the second mounting part 220 forms an exterior surface that covers a part of the first connection part 60L.

A first cover support part 231 and a second cover support part 232 are formed on the upper end edge of the cover part 230. The first cover support part 231 and the second cover support part 232 are examples of the “cover support part” of the present disclosure.

The front end of the first cover support part 231 is located at the left end of a portion of the upper end edge of the cover part 230, in which the portion curves in an arc shape on the front side. The rear end of the first cover support part 231 is located at the middle part of a portion of the upper end edge of the cover part 230, in which the portion extends in the forward-and-rearward direction.

The second cover support part 232 is located at a portion of the upper end edge of the cover part 230, in which the portion extends in the width direction on the front side and left side and protrudes in a substantially trapezoidal shape.

### First Fitting Part

As illustrated in FIG. 16, two first fitting parts 221 are formed in the second mounting part 220 of the second support part 200. Each of the first fitting parts 221 protrudes from the second side surface 220S of the second mounting part 220 in the fitting direction. Each of the first fitting parts 221 protrudes from the second side surface 220S to one side in the width direction.

The first fitting part 221 located on the rear end side of the second mounting part 220 is a cylindrical protrusion having an outer diameter large enough to fit into the first fitted part 121.

The first fitting part 221 located on the front end side of the second mounting part 220 is a roughly rectangular pillar-shaped protrusion having an abutment part 221T and extending in the forward-and-rearward direction. In the abutment part 221T, a part below the outer circumferential surface of the first fitting part 221 is formed in a flat shape.

### Second Fitted Part

Two second fitted parts 222 are formed in the second mounting part 220 of the second support part 200. Each of the second fitted parts 222 is located above the second side surface 220S of the second mounting part 220, and is recessed in the fitting direction from a printer portion 220N located away from the second side surface 220S on the other side in the width direction. Each of the second fitted parts 222 is recessed from the printer portion 220N toward the other side in the width direction.

As illustrated in FIG. 10, each of the second fitted parts 222 is rectangular when viewed in the width direction. The front second fitted part 222 is located below the rear second fitted part 222.

### Connection Between First Support Part and Second Support Part

The first support part 100 in a state where the first fixing part 110 is fixed to the panel base 11 of the panel housing 10, and the second support part 200 in which the second fixing part 210 is fixed to the base part 52 of the lower housing 50 are connected to each other as follows.

First, a worker performing assembly work holds the first support part 100 at a position spaced apart from the second support part 200 on one side in the width direction and upwards. The worker then abuts the bottom surface 120D of the first mounting part 120 against the upper surface 210U of the second fixing part 210 in a state in which the first side surface 120S of the first mounting part 120 is spaced apart from the second side surface 220S of the second mounting part 220 to one side in the width direction.

The worker then moves the first mounting part 120 toward the other side in the width direction and brings the first side surface 120S to be closer to the second side surface 220S. As a result, the front first fitting part 221 is inserted into the front first fitted part 121. The rear first fitting part 221 is inserted into the rear first fitted part 121. The front second fitting part 112 is inserted into the front second fitted part 222. The rear second fitting part 112 is inserted into the rear second fitted part 222.

Then, as illustrated in FIG. 11, the worker causes the first side surface 120S and the second side surface 220S to abut on each other in the width direction.

As a result, as illustrated in FIG. 9, the front first fitted part 121 is fitted into the front first fitting part 221. At this time, the receiving part 121T of the front first fitted part 121 receives the abutment part 221T of the front first fitting part 221 from below.

As illustrated in FIG. 9 and FIG. 11, the rear first fitted part 121 is fitted into the rear first fitting part 221.

As illustrated in FIG. 10 and FIG. 11, the front second fitted part 222 is fitted into the front second fitting part 112. As illustrated in FIG. 10, the rear second fitted part 222 is fitted into the rear second fitting part 112. The front set of the second fitting part 112 and the second fitted part 222 is located lower than the rear set of the second fitting part 112 and the second fitted part 222.

Finally, as illustrated in FIG. 9 and FIG. 11, the worker couples the first mounting part 120 to the second mounting part 220 by inserting four screws into the respective screw insertion holes 120F of the first mounting part 120 and screwing them into the respective screw holes 220F of the second mounting part 220.

As a result, in a state where the first mounting part 120 is located closer to one side in the width direction than to the second mounting part 220 and the first side surface 120S and the second side surface 220S come into abutment with each other in the width direction, the first support part 100 and the second support part 200 are connected to each other, and the support part 19 supports the panel housing 10.

In a state where the first support part 100 and the second support part 200 are connected to each other, the bottom surface 120D of the first mounting part 120 and the upper surface 210U of the second fixing part 210 face each other with a first gap G1 in the upward-and-downward direction.

The first gap G1 is set to a size that allows abutment of the bottom surface 120D of the first mounting part 120 and the upper surface 210U of the second fixing part 210, in a case where the pressing force F1 is applied to the operation panel 18. In the present embodiment, the first gap G1 is about 0. several mm to 1. several mm.

As illustrated in FIGS. 9 and 10, the first cover support part 231 is located widthwise away from the first support part 100 and abuts on the panel base 11 from below to support the panel housing 10. The second cover support part 232 is located in front of the first support part 100 and abuts on the panel base 11 from below to support the panel housing 10.

As illustrated in FIG. 9, the wire harness 10W passes through the opening 11H of the panel housing 10, then passes only through the first support part 100 of the support part 19, and further passes through the left side surface of the first connection part 60L of the connection part 60 so as to be routed to the inside of the lower housing 50.

In the present embodiment, the multifunction printer 1 has only one type of the second support part 200, as illustrated in FIGS. 9 to 11 and 16 to 18. On the other hand, the multifunction printer 1 has two types of the first support parts 100, such as a first type corresponding to the operation panel 18 and the panel housing 10 of the “large” and “small” sizes, as illustrated in FIGS. 6, 7, 9 to 12, 14 and 15, and a second type corresponding to the operation panel 18 and the panel housing 10 of the “medium” size, as illustrated in FIG. 8.

As illustrated in FIGS. 6 and 7, the first fixing part 110 of the first support part 100 of the first type is located at the center of the operation panel 18 and the panel housing 10 of the “large” and “small” sizes in the width direction.

On the assumption that the first support part 100 of the first type is applied to the operation panel 18 of the “medium” size, the first fixing part 110 of the first support part 100 of the first type becomes biased to the other side of the operation panel 18 and the panel housing 10 of the “medium” size in the width direction.

As illustrated in FIG. 8, the first fixing part 110 of the second type of the first support part 100 extends further to one side in the width direction than the first fixing part 110 of the first type of the first support part 100 such that the fixing part is located at the center of the operation panel 18 and the panel housing 10 of the “medium” size in the width direction.

In addition, in the present embodiment, although not illustrated, when a heavy panel housing 10 is supported, the first support part 100 and the second support part 200 of a type having high strength are used.

### Exterior Cover

As illustrated in FIG. 2 and FIG. 11, the multifunction printer 1 is provided with an exterior cover 80. The exterior cover 80 is located closer to one side in the width direction than to the first connection part 60L of the connection part 60, the first support part 100, and the second support part 200, and extends in the upward-and-downward direction and the forward-and-rearward direction.

The exterior cover 80 forms an exterior surface that covers the first connection part 60L and the first support part 100. In the present embodiment, the exterior cover 80 is a resin member manufactured by injection molding of a thermoplastic resin or the like.

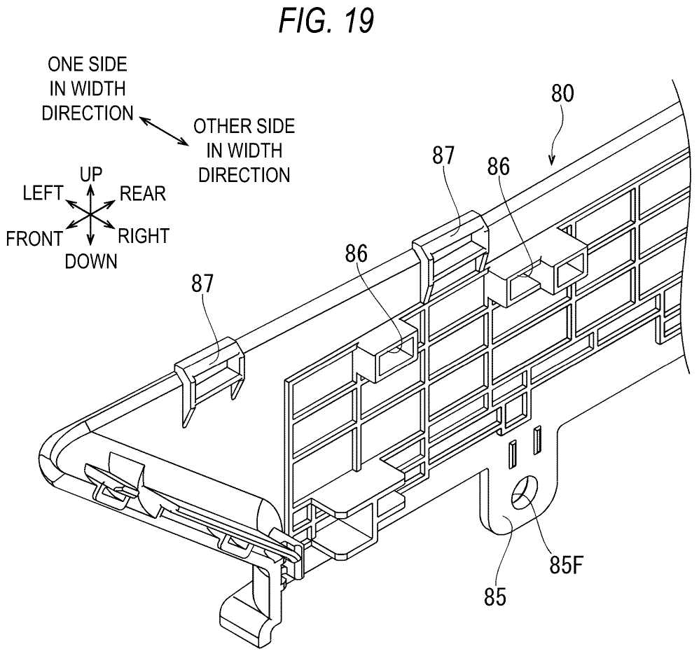

As illustrated in FIG. 19, a cover fixing part 85 is formed on the lower end side of the exterior cover 80 so as to protrude downwards. The cover fixing part 85 is formed with a screw insertion hole 85F. In FIG. 19, one front cover fixing part 85 is illustrated, but the exterior cover 80 includes a plurality of cover fixing portions 85 arranged in the forward-and-rearward direction.

Two cover abutment part 86 and two cover protrusions 87 are formed on the upper end side of the exterior cover 80.

Each of the cover abutment parts 86 is a protruding portion that protrudes toward the other side in the width direction from the back surface facing the other side in the width direction of the exterior cover 80. The cover abutment parts 86 are spaced apart from each other in the forward-and-rearward direction.

Each of the cover protrusions 87 protrudes slightly toward the other side in the width direction from a position on the back surface of the exterior cover 80, in which the position is higher than the respective cover abutment parts 86, and further protrudes upwards than the upper end edge of the exterior cover 80. The respective cover protrusions 87 are spaced apart from each other in the forward-and-rearward direction.

As illustrated in FIG. 5, a plurality of screw holes 59F are formed side by side in the forward-and-rearward direction in a left end surface of the joint cover 59, in which the left end surface is located closer to one side in the width direction than to the first connection part 60L and the base part 52.

Each of the cover fixing parts 85 is coupled to the left end surface of the joint cover 59 by inserting a plurality of screws into the respective screw insertion holes 85F and screwing them into the respective screw holes 59F of the joint cover 59. In this manner, the lower end side of the exterior cover 80 is fixed to the lower housing 50. As illustrated in FIG. 11, each of the cover abutment parts 86 abuts on the first mounting part 120 in the width direction.

As illustrated in FIG. 11 to FIG. 13, the panel base 11 includes an opposing wall 11W. As illustrated in FIG. 11, the opposing wall 11W is located closer to one side in the width direction than to the upper end of the exterior cover 80 and each of the cover protrusions 87, protrudes downwards, and extends in the forward-and-rearward direction.

As illustrated in FIG. 2, the upper end of the exterior cover 80 and each of the cover protrusions 87 are opposed to the opposing wall 11W so as not to be exposed.

As illustrated in FIG. 11, the lower end of the opposing wall 11W and the upper end of the exterior cover 80 and each of the cover protrusions 87 face each other across a second gap G2 in the width direction.

The second gap G2 is set to a size enabling abutment of the upper end of the exterior cover 80 and each of the cover protrusions 87, in a case where the pressing force F1 is applied biased toward one side in the width direction of the panel housing 10.

### Effects of Action

In the multifunction printer 1, as illustrated in FIGS. 6 to 8, in the case of the first support part 100 and the second support part 200, two types of the first support part 100 corresponding to the operation panel 18 having different sizes (“large”, “medium”, and “small”) are prepared, and the panel housing 10 for housing the operation panel 18 having any size can be supported by the support part 19 including the second support part 200 and the first support part 100 appropriately selected according to the operation panel 18 having any size.

For example, when the first support part 100 of the first type illustrated in FIGS. 6 and 7 is used for the operation panel 18 and the panel housing 10 of the “medium” size such that deviation of overhang of the panel housing 10 becomes large, the deviation of the overhang can be reduced by using the first support part 100 of the second type illustrated in FIG. 8 for the operation panel 18 and panel housing 10 of the “medium” size.

Furthermore, when supporting the heavy panel housing 10, the first support part 100 and the second support part 200 each serving as a high strength type can be used.

As a result, the multifunction printer 1 can secure the strength to withstand the pressing force F1 acting on the operation panel 18 without connecting the panel housing 10 to the upper housing 20.

Accordingly, in the case of the multifunction printer 1, it is required to design, manufacture, and store components for a plurality of types of the panel housing 10, that is, the panel base 11 and the panel cover 12, which have shapes that respectively match the different sizes of the operation panels 18, whereas it is not required to design, manufacture, and store components for a plurality of types of the upper housing 20, that is, the flat base 21 and the upper surface cover 22, which have shapes that respectively match the different sizes of the operation panels 18, and it is also not required to design, manufacture, and store components for a plurality of types of the connection parts 60, that is, the join covers 59, which have shapes that respectively match the different sizes of the operation panels 18.

Accordingly, in the multifunction printer 1 of the embodiment, in a configuration in which the operation panels 18 having different sizes are formed to be integrated with the upper housing 20, it is possible not only to secure the strength to withstand the pressing force F1 applied to the operation panel 18 without connecting the panel housing 10 to the upper housing 20, but also to reduce the number of housing components to be stored when a plurality of types of products are manufactured.

As a result, the multifunction printer 1 can reduce the waste of components. In the past, since the panel housing 10 was designed, manufactured, and stored according to a model change of a product, the panel housing 10 before the model change became unusable and had to be discarded. However, according to the present embodiment, the panel housing 10 before the model change can be used even after the model change. In other words, the multifunction printer 1 has high sustainability as sustainable development of the human, society, and global environment.

Furthermore, in this multifunction printer 1, as illustrated in FIG. 9, each of the first fitting parts 221 formed on the second support part 200 protrudes in the fitting direction. Each of the first fitted parts 121 formed on the first support part 100 is recessed in the fitting direction and is fitted into a corresponding one of the first fitting parts 221. As illustrated in FIG. 12, each of the second fitting parts 112 formed on the first support part 100 protrudes in the fitting direction. As illustrated in FIG. 10, each of the second fitted parts 222 formed on the second support part 200 is recessed in the fitting direction and is fitted into a corresponding one of the second fitting parts 112. The fitting direction is perpendicular to the pressing force F1 applied to the operation panel 18. With this configuration, the pressing force F1 does not act in a direction to remove each of the first fitting parts 221 from each of the first fitted parts 121, and does not act in a direction to remove each of the second fitting parts 112 from each of the second fitted parts 222, so that the support part 19 can preferably receive the pressing force F1. Furthermore, in this multifunction printer 1, a positional relationship between the first support part 100 and the second support part 200 is determined simply by fitting each of the first fitting parts 221 into a corresponding one of the first fitted parts 121 and fitting each of the second fitting parts 112 into a corresponding one of the second fitted parts 222, thereby making it possible to simplify assembly work.

Furthermore, in the multifunction printer 1, as illustrated in FIGS. 9 and 11, in a state in which the first support part 100 and the second support part 200 are connected to each other, the first side surface 120S of the first mounting part 120 and the second side surface 220S of the second mounting part 220 come into abutment with each other in the width direction, and the bottom surface 120D of the first mounting part 120 and the upper surface 210U of the second fixing part 210 face each other with the first gap G1 in the upward-and-downward direction interposed therebetween. The first gap G1 is set to a size that allows abutment when pressing force F1 is applied to the operation panel 18. With this configuration, even if the first support part 100 is twisted relative to the second support part 200 by the pressing force F1 applied to the operation panel 18, the first gap G1 becomes zero and the bottom surface 120D of the first mounting part 120 and the upper surface 210U of the second fixing part 210 abut on each other, thereby being able to withstand the twisting. As a result, this multifunction printer 1 can suppress deformation of the support part 19.

In addition, in the multifunction printer 1, as illustrated in FIG. 9, when the first support part 100 and the second support part 200 are connected to each other, the first mounting part 120 is located closer to one side in the width direction than to the second mounting part 220. Each of the first fitting parts 221 protrudes from the second side surface 220S of the second mounting part 220 toward one side in the width direction. Each of the first fitted parts 121 is recessed from the first side surface 120S of the first mounting part 120 toward one side in the width direction and is fitted into a corresponding one of the first fitting parts 221. As illustrated in FIG. 12, each of the second fitting parts 112 protrudes from the first fixing part 110 toward the other side in the width direction. As illustrated in FIG. 10 and FIG. 11, each of the second fitted parts 222 is located above the second side surface 220S of the second mounting part 220 and is recessed in the other direction in the width direction from the printer portion 220N located away from the second side surface 220S in the other direction in the width direction so as to be fitted into a corresponding one of the second fitting parts 112. The fitting direction is a direction toward one side in the width direction for each of the first fitting parts 221 and each of the first fitted parts 121, and is a direction toward the other side in the width direction for each of the second fitting parts 112 and each of the second fitted parts 222. With this configuration, even if the first support part 100 is twisted relative to the second support part 200 by the pressing force F1 applied to the operation panel 18, a connected configuration by fitting at a plurality of points can reliably withstand the twisting.

Furthermore, in the multifunction printer 1, as illustrated in FIG. 9, two sets of the first fitting parts 221 and the first fitted parts 121 are provided. In the rear set of the first fitting part 221 and the first fitted part 121, the first fitting part 221 is a cylindrical protrusion, and the first fitted parts 121 is a hole having a cylindrical inner circumferential surface. In the front set of the first fitting part 221 and the first fitted part 121, the first fitting part 221 is a protrusion having the abutment part 221T, and the first fitted part 121 is a hole having the receiving part 121T that receives the abutment part 221T from below. These two sets of the first fitting parts 221 and the first fitted parts 121 allow a positional relationship between the first support part 100 and the second support part 200 to be determined with high accuracy.

Furthermore, in the multifunction printer 1, as illustrated in FIG. 10, the panel housing 10 is inclined such that the front end of the multifunction printer is located lower than the rear end thereof. Two sets of the second fitting parts 112 and the second fitted parts 222 are provided. The front set of the second fitting part 112 and the second fitted part 222 is located lower than the rear set of the second fitting part 112 and the second fitted part 222. In this manner, by arranging the two sets of the second fitting parts 112 and the second fitted parts 222 with a step according to the inclination of the panel housing 10, the pressing force F1 applied to the operation panel 18 can be easily released to the base part 52 of the lower housing 50.

Furthermore, in the multifunction printer 1, as illustrated in FIG. 19, the cover fixing part 85 that is fixed to the lower housing 50 is formed on the lower end side of the exterior cover 80. As illustrated in FIG. 11 and FIG. 19, the upper end side of the exterior cover 80 has two cover abutment parts 86 that abut on the first mounting part 120 in the width direction. As illustrated in FIG. 11, the lower end of the opposing wall 11W of the panel housing 10, the upper end of the exterior cover 80, and each cover protrusion 87 face each other with the second gap G2 in the width direction interposed therebetween. The second gap G2 is set to a size enabling abutment when the pressing force F1 is applied biased toward one side in the width direction of the panel housing 10. With this configuration, even if a portion of the panel housing 10 that overhangs on one side in the width direction is pressed such that the panel housing 10 is twisted, the second gap G2 becomes zero such that the lower end of the opposing wall 11W abuts on the upper end of the exterior cover 80 and each cover protrusion 87, thereby making it possible to withstand the twisting. As a result, the multifunction printer 1 can suppress deformation of the panel housing 10.

Furthermore, in the multifunction printer 1, as illustrated in FIGS. 6 to 8, the portion 12B located on the rear and left end side of the panel cover 12 covers the front and left end corner of the upper surface cover 22 from above. This configuration makes it possible to prevent a boundary between the rear end of the panel cover 12 and the front end of the upper surface cover 22 of the upper housing 20 from being conspicuous. Additionally, this configuration makes it possible to reduce a sense of incongruity in design even if the operation panel 18 having a different size is formed to be integrated with the upper housing 20.

Furthermore, in the multifunction printer 1, as illustrated in FIGS. 9 and 10, the first cover support part 231 and the second cover support part 232 are formed on the upper end edge of the cover part 230, in which the first and second cover support parts abut on the panel housing 10 from below and support the panel housing 10. With this configuration, even if the pressing force F1 is applied to the operation panel 18, the first cover support part 231 and the second cover support part 232 of the second support part 200 can suppress rattling of the panel housing 10.

Furthermore, in the multifunction printer 1, the first cover support part 231 is located away from the first support part 100 in the width direction perpendicular to the upward-and-downward direction and the forward-and-rearward direction, and extends in the forward-and-rearward direction. The second cover support part 232 is located in front of the first support part 100 and extends in the width direction. With this configuration, even if the pressing force F1 is applied to the operation panel 18, the first cover support part 231 and the second cover support part 232 can reliably suppress rattling of the panel housing 10.

Furthermore, in the multifunction printer 1, as illustrated in FIG. 9, after the wire harness 10W passes through the opening 11H formed in the base part 11B of the panel housing 10, the wire harness is guided by the guide parts 100W1, 100W2, and 100W3 of the first support part 100 and passes only through the first support part 100 of the support part 19. Thereafter, the wire harness passes through the first connection part 60L of the connection part 60 and is routed to the inside of the lower housing 50. In other words, the wire harness 10W does not pass through the second support part 200 that is fixed to the base part 52 of the lower housing 50. Therefore, by fixing the first support part 100 to the panel housing 10 and assembling the first support part 100 with the second support part 200 in a state in which the guide parts 100W1, 100W2, and 100W3 of the first support part 100 guide the wire harness 10W, the work of routing the wire harness 10W to the inside of the lower housing 50 can be simplified.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the embodiments, the fitting direction is parallel to the width direction, but the present disclosure is not limited to this configuration. For example, the fitting direction may be parallel to the forward-and-rearward direction.

What is claimed is:

1. A multifunction printer comprising:
an image forming unit configured to form an image on a sheet;
an image reading unit configured to read an image of a document;
an operation panel configured to receive an operation input;
a lower housing configured to house the image forming unit;
an upper housing configured to house the image reading unit, the upper housing being located above the lower housing;
a panel housing configured to house the operation panel, the panel housing being located above the lower housing and located in front of the upper housing;
a connection part connecting the lower housing to the upper housing; and
a support part configured to support the panel housing, the support part being located between the lower housing and the panel housing in an upward-and-downward direction, the support part being located in front of the upper housing and the connection part,
wherein the support part includes:
a first support part fixed to the panel housing; and
a second support part fixed to the lower housing and configured to be connected to the first support part.

2. The multifunction printer according to claim 1,
wherein the support part includes:
a fitting part formed on one of the first support part and the second support part, the fitting part protruding in a fitting direction perpendicular to a first direction in which the operation panel is pressed; and
a fitted part formed in an other of the first support part and the second support part, the fitted part being recessed in the fitting direction so as to be fitted into the fitting part.

3. The multifunction printer according to claim 2,
wherein the first support part includes:
a first fixing part extending along the panel housing, the first fixing part being fixed to the panel housing; and
a first mounting part connected to the first fixing part, the first mounting part extending toward the lower housing,
the second support part includes:
a second fixing part extending along the lower housing, the second fixing part being fixed to the lower housing; and
a second mounting part connected to the second fixing part, the second mounting part extending toward the panel housing,
in a state where the first support part and the second support part are connected to each other, a first side surface of the first mounting part and a second side surface of the second mounting part abut on each other in a second direction parallel to the fitting direction, and a bottom surface of the first mounting part and an upper surface of the second fixing part face each other across a first gap in an upward-and-downward direction, and
the first gap is set to a size in which the bottom surface of the first mounting part is configured to abut on the upper surface of the second fixing part in a case where the operation panel is pressed in the first direction.

4. The multifunction printer according to claim 3,
wherein in a state where the first support part and the second support part are connected to each other, the first mounting part is located closer to one side in the second direction than is the second mounting part,
the fitting part includes:
a first fitting part protruding from the second side surface of the second mounting part toward the one side in the second direction; and
a second fitting part protruding from the first fixing part toward the other side in the second direction,
the fitted part includes:
a first fitted part recessed from the first side surface of the first mounting part toward the one side in the second direction, the first fitted part being fitted into the first fitting part; and
a second fitted part recessed from a portion of the second mounting part, the portion being located above the second side surface, toward the other side in the second direction, the second fitted part being fitted into the second fitting part, and
the fitting direction is a direction toward the one side in the second direction in the first fitting part and the first fitted part, and is a direction toward the other side in the second direction in the second fitting part and the second fitted part.

5. The multifunction printer according to claim 4,
wherein the multifunction printer includes two pairs of the first fitting part and the first fitted part,
in one pair of the first fitting part and the first fitted part, the first fitting part is a cylindrical protrusion, and the first fitted part is a hole having a cylindrical inner circumferential surface, and
in an other pair of the first fitting part and the first fitted part, the first fitting part is a protrusion having an abutment part, wherein a part of an outer circumferential surface of the first fitting part is formed in a flat shape so as to form the abutment part, and the first fitted part is a hole having a receiving part configured to receive the abutment part from below, wherein a part of an inner circumferential surface of the first fitted part is formed in a flat shape so as to form the abutment part.

6. The multifunction printer according to claim 4,
wherein the panel housing is inclined such that a front end of the panel housing is located lower than a rear end of the panel housing,
the second direction is a width direction perpendicular to the upward-and-downward direction and a forward-and-rearward direction,
the multifunction printer includes two pairs of the second fitting part and the second fitted part, and
one pair of the second fitting part and the second fitted part is located in front of and below an other pair of the second fitting part and the second fitted part.

7. The multifunction printer according to claim 3,
wherein the second direction is the width direction perpendicular to the upward-and-downward direction and the forward-and-rearward direction, and
in a state where the first support part and the second support part are connected to each other, the first mounting part is located closer to the one side in the width direction than is the second mounting part,
the multifunction printer further comprising an exterior cover located closer to the one side in the width direction than is the connection part, the first support part, and the second support part, the exterior cover extending in the upward-and-downward direction and the forward-and-rearward direction,
wherein the exterior cover includes a cover fixing part formed on a lower end side of the exterior cover, the cover fixing part being fixed to the lower housing,
the exterior cover includes a cover abutment part formed on an upper end side of the exterior cover, the cover abutment part abutting on the first mounting part in the width direction,
the panel housing includes:
a base part to which the first fixing part is fixed; and
an opposing wall located closer to the one side in the width direction than is the upper end of the exterior cover, the opposing wall protruding downwards and extending in the forward-and-rearward direction,
a lower end of the opposing wall and the upper end of the exterior cover face each other across a second gap in the width direction, and
the second gap is set to a size in which the upper end of the exterior cover abuts on the lower end of the opposing wall in a case where pressing force in the first direction is applied biased toward the one side in the width direction of the panel housing.

8. The multifunction printer according to claim 1,
wherein the image reading unit includes a document glass disposed on an upper surface of the upper housing, the document glass including a document placement surface on which the document to be read is placed,
the upper housing includes an upper surface cover covering an outer circumferential edge of the document glass,
the panel housing includes a panel cover covering an outer circumferential edge of the operation panel, and
a part of a rear end side of the panel cover is configured to cover, from above, a part of a front end side of the upper surface cover.

9. The multifunction printer according to claim 1,
wherein the second support part includes a cover part forming an exterior surface of the second support part, and
the cover part includes a cover support part formed at an upper end edge of the cover part, the cover support part abutting on the panel housing from below and supporting the panel housing.

10. The multifunction printer according to claim 9,
wherein the cover support part includes:
a first cover support part located away from the first support part in the width direction perpendicular to the upward-and-downward direction and the forward-and-rearward direction, the first cover support part extending in the forward-and-rearward direction; and
a second cover support part located in front of the first support part, the second cover support part extending in the width direction.

11. The multifunction printer according to claim 1, further comprising a wire harness that is an assembly of a plurality of electrical wirings connected to the operation panel,
wherein the wire harness passes through an opening formed in a bottom wall of the panel housing, then passes through only the first support part of the support part, and further passes through the connection part so as to be routed to an inside of the lower housing, and
the first support part includes a guide part configured to guide the wire harness.
